(19) United States
(12) Patent Application Publication
(10) Pub. No.: US 2006/0214021 A1
(43) Pub. Date: Sep. 28, 2006

(54) Hydraulic coupler and fuel injection valve

(75) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(73) Assignee: ROBERT BOSCH GMBH, Stuttgart (DE)

(21) Appl. No.: 10/565,072

(22) PCT Filed: Jun. 9, 2004
(86) PCT No.: PCT/DE04/01198

§ 371 Date: Jan. 18, 2006

(30) Foreign Application Priority Data
Jul. 19, 2003 (DE) 103 32 874.2

(51) Int. Cl. B05B 1/08

(52) U.S. Cl. 239/102.2

(57) ABSTRACT

A hydraulic coupler for a fuel injection valve, having a first booster piston that can be coupled to an actuator and a second booster piston that can be coupled to a nozzle needle and a lifetime filling of a hydraulic fluid hydraulically coupling the two booster pistons to each other. One end of one of the second booster pistons is guided in an end of the first booster piston defined a booster chamber between the booster piston which communicates with an additional enclosure for hydraulic fluid, which is sealed shut by means of a spring/sealing element.

The invention relates to a hydraulic coupler for a fuel injection valve, having a booster piston that can be coupled to an actuator, in particular a piezoelectric actuator, and having an additional booster piston that can be coupled to a nozzle needle; a lifetime filling of a hydraulic fluid is provided between the two booster pistons to hydraulically couple the two booster pistons to each other. The invention also relates to a fuel injection valve.

### PRIOR ART

Hydraulic couplers serve to compensate for temperature differences between the actuator and the nozzle needle. The term lifetime filling is intended to mean that the coupler is filled with hydraulic fluid before being placed into service and this filling is neither replaced nor replenished over the entire service life. As a result, strict requirements must be met with regard to its leakproofness. Conventional couplers are often complex in design and/or expensive to fill.

The object of the invention, therefore, is to create a hydraulic coupler and a fuel injection valve of the type described at the beginning that are simply designed and inexpensive to manufacture. In addition, this new coupler should be inexpensive to fill.

### ADVANTAGES OF THE INVENTION

In a hydraulic coupler for a fuel injection valve, having a booster piston that can be coupled to an actuator, in particular a piezoelectric actuator, and having an additional booster piston that can be coupled to a nozzle needle, in which a lifetime filling of a hydraulic fluid is provided between the two booster pistons to hydraulically couple the two booster pistons to each other, the object of the invention is attained in that one end of one of the booster pistons is guided in an end of the other booster piston and in that a booster chamber, which is situated between the end of the one booster piston and the other booster piston, communicates with an additional enclosure for hydraulic fluid, which is sealed shut by means of a spring/sealing element. On the one hand, the spring/sealing element serves to seal the additional enclosure for the hydraulic fluid. On the other hand, the spring/sealing element can be used to set the initial stress for the filling pressure.

A preferred embodiment of the coupler is characterized in that the one booster piston contains a connecting conduit that connects the booster chamber to the additional enclosure for hydraulic fluid. This simplifies the design of the coupler significantly.

Another preferred exemplary embodiment of the coupler is characterized in that the connecting conduit is equipped with a throttle. The throttle permits the booster chamber to be filled after an injection and simultaneously prevents an uncontrolled escape of a large volumetric flow of hydraulic fluid from the booster chamber.

Another preferred exemplary embodiment of the coupler is characterized in that the throttle is rounded on one side in the filling direction. This makes it even easier to fill the booster chamber.

Another preferred exemplary embodiment of the coupler is characterized in that the connecting conduit has a through hole that extends in the longitudinal direction of the one booster piston. The through hole permits the coupler to be filled easily before it is first placed into service.

Another preferred exemplary embodiment of the coupler is characterized in that the through hole is sealed shut by a sealing element at the end of the one booster piston oriented away from the booster chamber. The sealing element can, for example, be a ball that is pressed against an associated seat by a screw.

Another preferred exemplary embodiment of the coupler is characterized in that the additional enclosure for hydraulic fluid is comprised of an annular chamber situated radially outside the one piston. Preferably, the annular chamber communicates with the booster chamber via a through hole extending in the one piston in the radial direction.

Another preferred exemplary embodiment of the coupler is characterized in that the annular chamber is partially delimited in the axial direction by the other piston and by a stationary housing. This arrangement is particularly easy to implement from a production engineering standpoint.

Another preferred exemplary embodiment of the coupler is characterized in that a spring element is clamped between the other piston and the stationary housing part. The spring element acts as a return spring for the other booster piston.

Another preferred exemplary embodiment of the coupler is characterized in that the additional enclosure for hydraulic fluid is delimited at the radial outside by a convoluted bellows. The convoluted bellows consequently functions both as a sealing element and as a spring element.

Another preferred exemplary embodiment of the coupler is characterized in that the convoluted bellows can be deformed in the radial direction. In this way, the convoluted bellows can generate the initial stress for the filling pressure.

In a fuel injection valve, the above-indicated object is attained by means of a coupler of the type described above.

### DRAWINGS

Other advantages, defining characteristics, and details of the invention ensue from the following description in which an exemplary embodiment is described in detail with reference to the drawings. The defining characteristics mentioned in the claims and in the specification can be essential to the present invention either individually or in arbitrary combinations with one another.

FIG. 1 shows a longitudinal section through a part of a fuel injection valve equipped with a hydraulic coupler;

FIG. 2 is an enlarged depiction of a convoluted bellows from FIG. 1, and

FIG. 3 is an enlarged depiction of a throttle from FIG. 1.

### DESCRIPTION OF THE EXEMPLARY EMBODIMENT

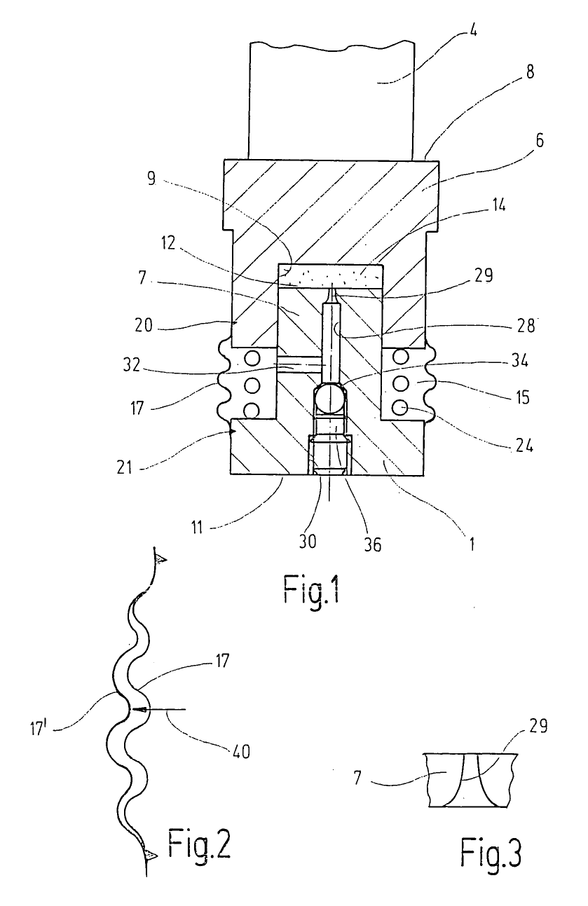

FIG. 1 shows a longitudinal section through a part of a fuel injection valve. In modern internal combustion engines, particularly motor vehicle engines, fuel injection valves inject the fuel, in particular gasoline, into the combustion chamber. The fuel injection valve has a valve housing 1 of which only an essentially annular body with a rectangular cross section is shown in FIG. 1 for the sake of clarity. The injection is triggered by a piezoelectric actuator 4, which acts on a first booster piston 6. The first booster piston 6 is hydraulically coupled to a second booster piston 7. At one end of the first booster piston 6, there is an essentially disk-shaped end surface 8 against which the piezoelectric actuator 4 rests. The other end of the first booster piston 6 contains a central blind hole 9 embodied essentially in the form of a circular cylinder.

One end of the second booster piston 7 is guided in the blind hole 9 in a sealed fashion. This guidance permits the two booster pistons 6 and 7 to move in relation to each other in the axial direction. The end surface 12 of the second booster piston 7 oriented toward the first booster piston 6 delimits a booster chamber 14 in the blind hole 9. The booster chamber 14 is filled with a hydraulic fluid such as silicone oil in order to permit a hydraulic coupling between the two booster pistons 6 and 7.

The booster chamber 14 communicates with an additional enclosure 15 situated radially outside the second booster piston 7, between the valve housing 1 and the first booster piston 6. The additional enclosure 15 is an annular chamber that is delimited on the radial inside by the second booster piston 7, is delimited in the axial direction by the first booster piston 6 and the valve housing 1, and is delimited on the radial outside by a convoluted bellows 17. The convoluted bellows 17 is attached to the first booster piston 6 in a sealed fashion by means of a welding seam 20. At the other end, the convoluted bellows 17 is attached to the valve housing 1 in a sealed fashion by means of a welding seam 21.

In the additional enclosure 15, a return spring 24, e.g. a helical compression spring, is prestressed in the axial direction between the first booster piston 6 and the valve housing 1. The return spring 24 serves to return the first booster piston 6 into its initial position after an actuation of the piezoelectric actuator 4.

A central through hole 28 is provided in the second booster piston 7, extending in the direction of the longitudinal piston axis. A throttle 29 with a restricted cross section is provided at the end of the through hole 28 oriented toward the booster chamber 14. A diametrical expansion 30 with an internal thread is provided at the other end of the through hole 28. In the region of the convoluted bellows 17, a cross bore 32 leads from the through hole 28 to the additional enclosure 15. At the end oriented away from the booster chamber 14, the central through hole 28 is a sealed shut by a ball-shaped sealing element 34 that is pressed against an associated seat by a screw 36 that is screwed into the internal thread of the diametrical expansion 30.

Before the initial operation, the booster chamber 14 and the additional enclosure 15 are filled with a hydraulic fluid such as silicone oil via the through hole 28 and the cross bore 32. After the filling, the through hole 28 is sealed shut by the ball-shaped sealing element 34 and the screw 36. The booster chamber 14 communicates with the additional enclosure 15 via the through hole 28 and the cross bore 32.

In FIG. 2, it is clear that the convoluted bellows 17 can be radially deformed in the direction of an arrow 40 as the additional enclosure 15 is filled. Such a radial deformation of the convoluted bellows 17 is indicated by the reference numeral 17′. The deformation of the convoluted bellows 17 toward 17′ makes it possible for an initial stress to be exerted on the filling pressure in the additional enclosure 15. This initial stress also prevails in the booster chamber 14 via the cross bore 32, the through hole 28, and the throttle 29.

FIG. 3 shows that the throttle 29 is embodied as rounded on its side oriented away from the booster chamber 14. The rounding facilitates the filling of the booster chamber 14.

The booster chamber 14 is sealed by the guidance between the two booster pistons 6 and 7. The throttle 29 is used to rapidly fill the booster chamber 14 after an injection. The initial stress for the pressure difference required to fill the booster chamber 14 is generated by the convoluted bellows 17, which performs both a sealing function and a spring function. The convoluted bellows 17 is designed so that it is able to expand not only in the axial direction but also in the radial direction.

1-12. (canceled)

13. A hydraulic coupler for a fuel injection valve comprising,
a booster piston having the capacity to be coupled to a piezoelectric actuator,
an additional booster piston having the capacity to be coupled to a nozzle needle,
a lifetime filling of a hydraulic fluid between the two booster pistons to hydraulically couple the two booster pistons to each other,
one end of one of the booster pistons being guided in an end of the other booster piston
a booster chamber situated between the end of the one booster piston and the other booster piston, and
an additional enclosure for hydraulic fluid, the additional enclosure being sealed shut by means of a spring/sealing element and communicating with said booster chamber.

14. The coupler according to claim 13, wherein the one booster piston comprises a connecting conduit that connects the booster chamber to the additional enclosure for hydraulic fluid.

15. The coupler according to claim 14, wherein the connecting conduit comprises a throttle.

16. The coupler according to claim 15, wherein the throttle is rounded on one side in the filling direction.

17. The coupler according to claim 14, wherein the connecting conduit comprises a through hole that extends in the longitudinal direction of the one booster piston.

18. The coupler according to claim 15, wherein the connecting conduit comprises a through hole that extends in the longitudinal direction of the one booster piston.

19. The coupler according to claim 16, wherein the connecting conduit comprises a through hole that extends in the longitudinal direction of the one booster piston.

20. The coupler according to claim 17, wherein the through hole is sealed shut by a sealing element at the end of the one booster piston oriented away from the booster chamber.

21. The coupler according to claim 13, wherein the additional enclosure for hydraulic fluid comprises an annular chamber situated radially outside the one piston.

22. The coupler according to claim 14, wherein the additional enclosure for hydraulic fluid comprises an annular chamber situated radially outside the one piston.

23. The coupler according to claim 15, wherein the additional enclosure for hydraulic fluid comprises an annular chamber situated radially outside the one piston.

24. The coupler according to claim 21, wherein the annular chamber is delimited in the axial direction by the other piston and by a stationary housing part.

25. The coupler according to claim 13, further comprising a spring element clamped between the other piston and the stationary housing part.

26. The coupler according to claim 14, further comprising a spring element clamped between the other piston and the stationary housing part.

27. The coupler according to claim 21, further comprising a spring element clamped between the other piston and the stationary housing part.

28. The coupler according to claim 13, further comprising a convoluted bellows delimiting the additional enclosure for hydraulic fluid at the radial outside.

29. The coupler according to claim 14, further comprising a convoluted bellows delimiting the additional enclosure for hydraulic fluid at the radial outside.

30. The coupler according to claim 17, further comprising a convoluted bellows delimiting the additional enclosure for hydraulic fluid at the radial outside.

31. The coupler according to claim 28, wherein the convoluted bellows is deformable in the radial direction.

32. A fuel injection valve equipped with a hydraulic coupler according to claim 13.
